(19) United States
(12) Patent Application Publication
(10) Pub. No.: US 2017/0124910 A1
(43) Pub. Date: May 4, 2017

(54) SYSTEM AND METHOD FOR ENABLING A USER TO OVERCOME SUBMISSIVENESS

(71) Applicants: Jonnalagadda Sasidhar, Sleepy Hollow, NY (US); Sreenidhi Sundaran, Bangalore (IN); Gopi Ambekar, Bangalore (IN)

(72) Inventors: Jonnalagadda Sasidhar, Sleepy Hollow, NY (US); Sreenidhi Sundaran, Bangalore (IN); Gopi Ambekar, Bangalore (IN)

(73) Assignee: DHARMA LIFE SCIENCES LLC, Sleepy Hollow, NY (US)

(21) Appl. No.: 15/002,418

(22) Filed: Jan. 21, 2016

Related U.S. Application Data
(63) Continuation-in-part of application No. 14/931,868, filed on Nov. 4, 2015.

(51) Int. Cl. G09B 19/00; A63F 9/00; G09B 5/02

(52) U.S. Cl. CPC G09B 19/00; G09B 5/02; A63F 9/00

(57) ABSTRACT

A system is provided for enabling a user to overcome submissiveness. The system is configured to enable the user to engage in a first and a second activity in a virtual environment, directed to rewire a first and a second defective wiring, respectively. The first defective wiring results in an individual inclining towards the fear of retaliation and/or losing good impression. The second defective wiring results in inability to weigh between the benefits of disagreeing and the fear of retaliation and/or losing good impression. Symptom of the first and the second defective wirings is submissiveness. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome submissiveness, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, submissiveness may be caused by genetic predisposition, exhibition of submissive behaviors by an individual's parents, the environment in which an individual was raised, where there is strict moral values and where they have been deprived of stating their needs, opinions and physical, emotional abuse, among others.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. A submissive person may be defensive, reclusive or indecisive and apologetic. Additionally a submissive person may prefer to relinquish their power to others and avoid being in control, fear about hurting other's feeling, fail to convey their concerns and needs and fail to say ‘no’ to others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome submissiveness, which can be classified as a weak personality trait based on the goals of the person.

### SUMMARY

An embodiment provides a system for enabling a user to overcome submissiveness. The system includes an activity module. The activity module is configured to enable the user to engage in at least a first activity in a virtual environment. The first activity is directed to rewire a first defective wiring of the brain. The first defective wiring results in inclination towards the fear of retaliation and/or losing good impression. The activity module is further configured to enable the user to engage in at least a second activity in the virtual environment. The second activity is directed to rewire a second defective wiring of the brain. The second defective wiring results in inability to weigh between the benefits of disagreeing and the fear of retaliation and/or losing good impression. Symptom of the first and the second defective brain wirings is submissiveness. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome submissiveness. The method includes enabling the user to engage in at least a first activity in a virtual environment. The first activity is directed to rewire a first defective wiring of the brain. The first defective wiring results in an individual inclining towards the fear of retaliation and/or losing good impression. The user is enabled to engage in at least a second activity in the virtual environment. The second activity is directed to rewire a second defective wiring of the brain. The second defective wiring results in inability to weigh between the benefits of disagreeing and the fear of retaliation and/or losing good impression. Symptom of the first and the second defective wirings is submissiveness. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome submissiveness. The system includes an activity module configured to enable the user to engage in at least a first activity in a virtual environment, wherein the first activity is directed to rewire a first defective wiring of the brain, wherein the first defective wiring results in inclination towards the fear of retaliation and/or losing good impression. The activity module is further configured to enable the user to engage in at least a second activity in the virtual environment, wherein the second activity is directed to rewire a second defective wiring of the brain, wherein the second defective wiring results in inability to weigh between the benefits of disagreeing and the fear of retaliation and/or losing good impression, wherein symptom of the first and the second defective wirings is submissiveness, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome submissiveness;

FIG. 2 is a block diagram of an exemplary activity module 200 to overcome submissiveness;

FIG. 2A is a block diagram of an exemplary behavioral traits database 202 of the activity module 200 to overcome submissiveness;

FIG. 2B is a block diagram of an exemplary collection of games 204 present in the activity module 200 to overcome submissiveness;

FIG. 2C is a block diagram of an exemplary actions database 206 of the activity module 200 to overcome submissiveness; and

FIG. 3 illustrates a flowchart of an exemplary method for overcoming submissiveness.

### DETAILED DESCRIPTION

I. OVERVIEW
II. PRINCIPLE
III. SYSTEM ARCHITECTURE
IV. MODULES OF SYSTEM TO OVERCOME SUBMISSIVENESS
V. METHOD FOR OVERCOMING SUBMISSIVENESS

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome submissiveness, which is a weak behavioral trait. The solution is based on a principle that genetic and environmental factors (may be referred to as “cause”) cause defects in human brain wiring (may be referred to as “defect”), and such defects in human brain wiring express themselves in the form of submissiveness (may be referred to as “symptoms”); hence, to overcome submissiveness, the defective brain wirings have to be rewired, thereby providing a wholesome and long term solution to weak behavioral traits.

In an embodiment, a system is provided to overcome submissiveness. The system may include an activity module. The activity module may be configured to enable the user to engage in activities in a virtual environment. The activities in the virtual environment facilitate rewiring of defective brain wirings, wherein the symptom of the defective brain wirings is submissiveness. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Submissiveness is a defensive behavior when an individual is under some social threat from a more powerful other where he/she is unable to express his/her needs and concerns particularly when other individual has conflicting needs.

Submissiveness is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to submissiveness, the brain of a submissive person is wired such that the person tends to be inclined towards the fear of retaliation and/or losing good impression, which is a defective brain wiring. Additionally, the brain of the submissive person is wired such that the individual fails to weigh between the benefits of disagreeing and the fear of retaliation and/or losing good impression, which may be considered as another defective brain wiring. Such defective brain wiring may have been caused by one or more of genetic predisposition, exhibition of submissive behaviors by an individual's parents, the environment in which an individual was raised, where there is strict moral values and where they have been deprived of stating their needs, opinions and physical, emotional abuse, among others.

Embodiments provide a solution to rewire the defective brain wirings (addressing the defect) rather than just addressing the behavioral trait (symptom) without addressing the core defect. The solution is directed towards rewiring the defective brain wirings such that the ability to focus more on the benefits of disagreeing is increased and ability to weigh between the benefits of disagreeing and the fear of retaliation and/or losing good impression is increased.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with submissiveness tend to incline towards the fear of retaliation and/or losing good impression and they fail to weigh between the benefits of disagreeing and the fear of retaliation and/or losing good impression. Different brain regions and neural network of the individual are responsible for such defects. Orbitofrontal cortexes (OFC), Basolateral amygdala (BLA), Centro medial amygdala (CMA) are the important brain regions or the blocks. When an individual is submissive, the stimuli are always associated with fear. The fear component is involved because of the excitation of neurons present in basolateral amygdala (BLA). BLA inhibits the neurons of centro medial amygdala (CMA) from getting excited. CMA is responsible for the dominant behaviour in an individual. Inhibiting the activation of CMA neurons leads to the enhancement of fear component. Apart from directly suppressing the activity of CMA, BLA excites a set of cortical neurons from orbito frontal cortex (OFC), which further increases the fear component by reducing the dominant and impulsive function of CMA. Thus coupling of OFC and also direct suppression of CMA activity by BLA leads to the expression of submissive behavior in an individual. Amygdala has two regions which are responsible for dominance and submissive behavior. BLA is responsible in increasing the fear component and leads to submissiveness; CMA is involved in increasing dominant and aggressive behavior.

### III. System Architecture

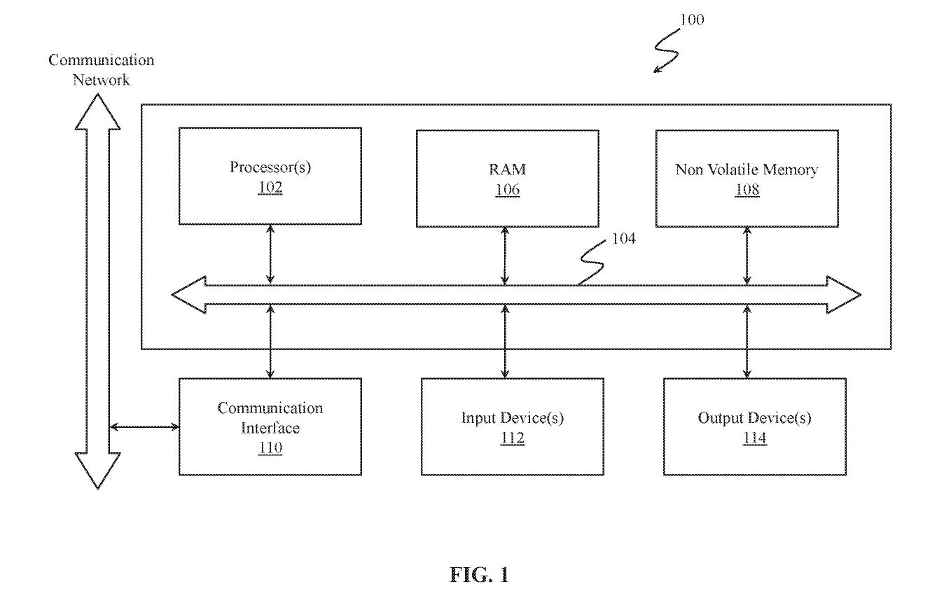

Referring to the figures, more particularly to FIG. 1, an exemplary architecture of an exemplary system 100 to overcome submissiveness is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Submissiveness

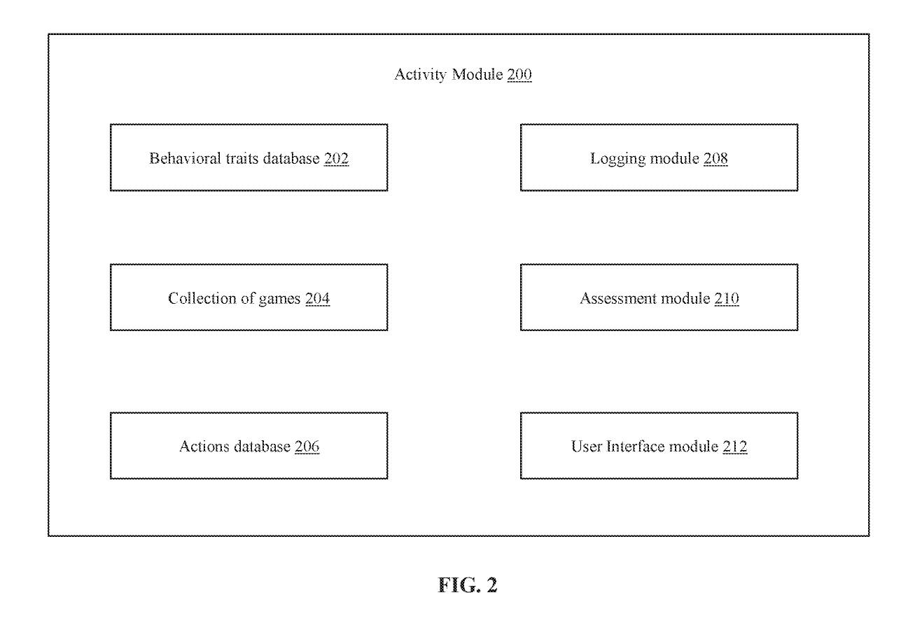

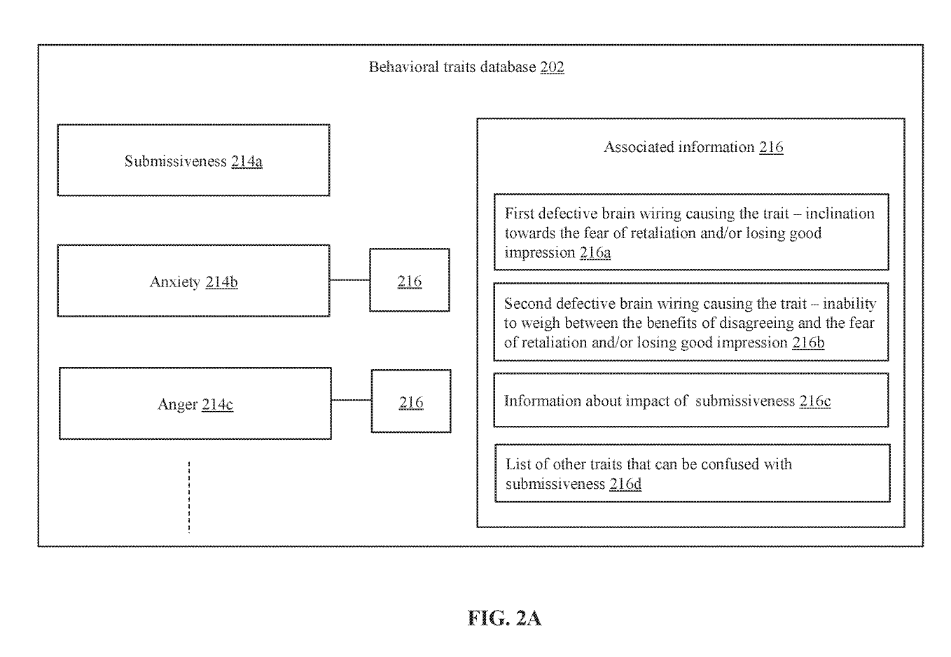

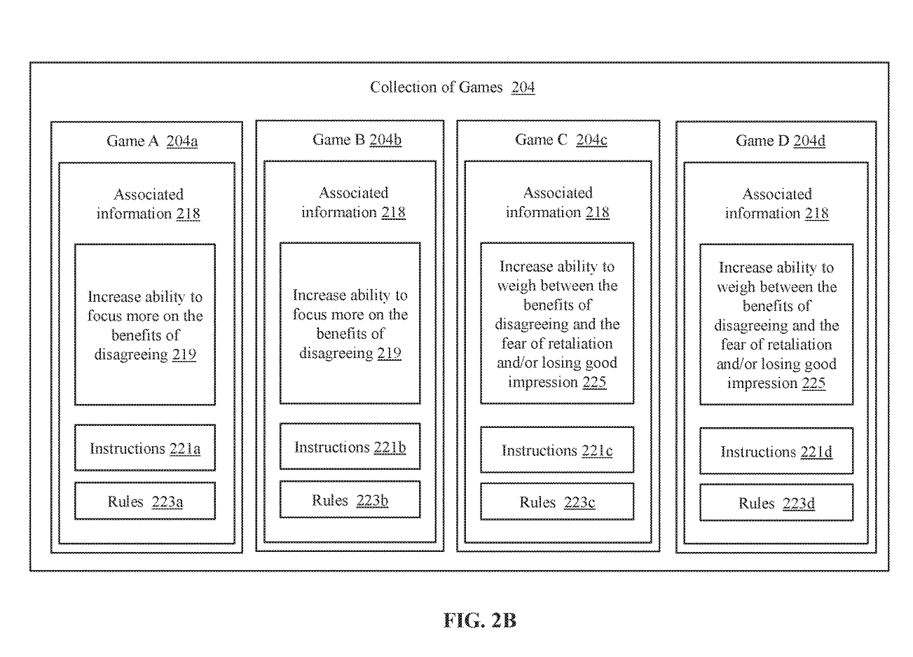

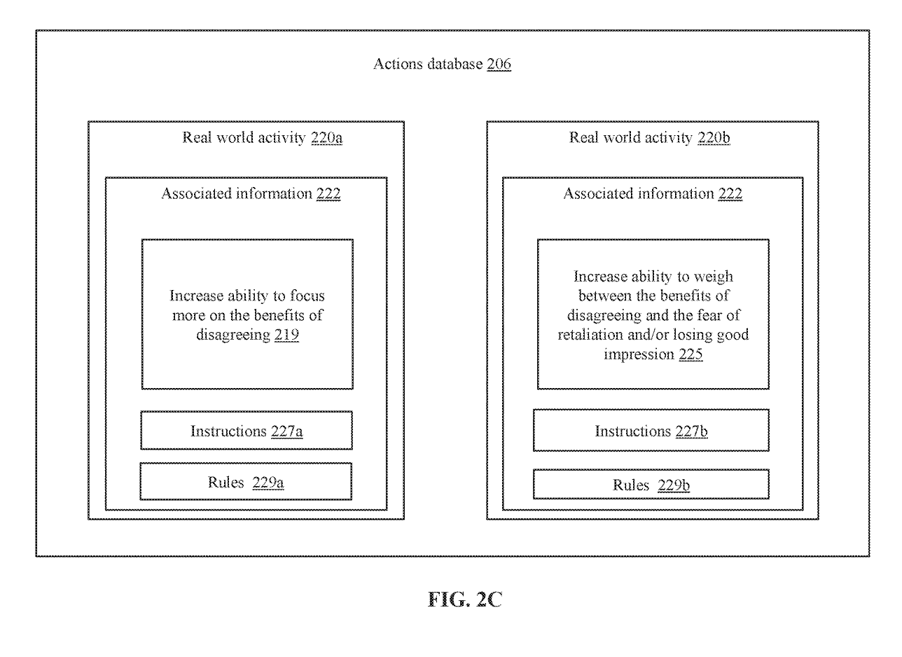

Referring to the figures, and more particularly to FIG. 2, the system 100 includes various modules for enabling users to overcome submissiveness. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, submissiveness 214a, anxiety 214b and anger 214c, among others. The traits database 202 may further include, with respect to one or more of the behavioral traits, information associated 216 with the trait 214.

With regards to submissiveness 214a, the associated information 216 may include information corresponding to the defective brain wirings (defects) 216a and 216b causing submissiveness (symptom of the defect), information about impact 216c of submissiveness 214a on a person, and a list 216d comprising one or more traits that may be confused with submissiveness 214a, among other information. Some or all of the associated information 216 may be displayed to the user of the activity module 200.

A first defective brain wiring 216a causing submissiveness 214a is the brain wiring causing an individual to incline towards the fear of retaliation and/or losing good impression. A second defective brain wiring 216b causing submissiveness 214a is the brain wiring causing an individual to fail in weighing between the benefits of disagreeing and the fear of retaliation and/or losing good impression.

In an embodiment, the information corresponding to the first and second defective brain wiring 216a, 216b causing submissiveness 214a enables the activity module 200 to select games, activities or actions to overcome submissiveness 214a.

In an embodiment, displaying the information corresponding to the defective brain wiring (defect) 216a, 216b causing submissiveness 214a helps the user in understanding the defects responsible for submissiveness 214a, thereby motivating the user to follow the instructions provided by the activity module 200.

Information about impact 216c of submissiveness 214a can include one or more of behaviors exhibited by a submissive person, such as, defensiveness, reclusiveness or indecisiveness and being apologetic, preferring to relinquish their power to others and avoid being in control, fearing about hurting other's feeling, failing to convey their concerns and needs and failing to say ‘no’ to others.

The list 216d of other traits that can be confused with submissiveness 214a include, introversion, low self esteem, social anxiety and high empathy among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome submissiveness 214a.

With regards to submissiveness 214a, the brain rewiring attempted to achieve to overcome submissiveness 214a includes rewiring the defective brain wirings 216a, 216b such that ability to focus more on the benefits of disagreeing is increased and ability to weigh between the benefits of disagreeing and the fear of retaliation and/or losing good impression is increased.

In an embodiment, the activity module 200 may display the information corresponding to the causes (genetic or environmental) that resulted in the defective brain wirings (defect) 216a, 216b, which in turn resulted in submissiveness 214a, thereby enabling the user to relate to the cause, defect and symptom of the defect, which results in a wholesome experience while working to overcome submissiveness 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204d (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, four different games 204a-204d are included in the collection of games 204. The three games 204a, 204b, 204c and 204d can be used by the activity module 200 to correct the defective brain wirings 216a and 216b by rewiring the brain to increase the ability to focus more on the benefits of disagreeing 219 and increase ability to weigh between the benefits of disagreeing and the fear of retaliation and/or losing good impression 225.

Game A 204a and Game B 204b are directed at rewiring 219 the brain to increase the ability to focus more on the benefits of disagreeing. The games, 204c and 204d are directed at rewiring 225 the brain to increase the ability to weigh between the benefits of disagreeing and the fear of retaliation and/or losing good impression.

Game A 204a may be designed to rewire the brain to increase the ability to focus more on the benefits of disagreeing 219. Game A 204a may be directed at facing and overcoming one's fear of retaliation. The instruction 221a may include recommendation to play the game 204a for a minimum duration every day. The rules 223a may allow proceeding to a next level in the game 204a once a desired level of performance is achieved.

In Game A 204a, the user may be provided with instructions 221a to pelt stone on the glass panels to achieve certain points hidden inside the panels. There are panels which hold shadow of a person and are distinct from others which hint the user at a shouting face. Rules 223a may provide recommendations that a shouting face will lead the user towards a difficult game. A limited number of stones are available to achieve the required (100) points. At the same time maximum number of points may be located in the panels with a shadow of a person. So if the user has to complete the level he has to target the areas near the blurred panel, which is both beneficial and also a risky task. But to win this kind of situation one must not fear about the risk and should go for the completion of the task.

Game B 204b may be designed to rewire the brain to increase the ability to focus more on the benefits of disagreeing 219. Game B 204b may be directed at facing and overcoming one's fear of losing good impression. The instruction 221b may include recommendation to play the game 204b for at least a predefined duration for a predefined number of days. The rules 223b may allow proceeding to a next level in the game 204b once a desired level of performance is achieved.

In Game B 204b, a situation and a plurality of associated facts may be presented to the user. The user has to choose a correct answer based on evaluation and analysis of the situation and the facts displayed which will be a subset of the ones below. One example is presented below.

Situation: Your friends are inviting you for a party and you are hesitant to go.

### Benefits of Disagreeing:

You have loads of work to complete and it would be tiring if you attend.
Your house is situated far-away and you might not be able stay for long to enjoy the party.
You would opt out from the party as you have gone to another party the previous week.
It is ok if you opt out from the party as there are many others who are going to the party.
You might consume alcohol in the party, so it might be difficult to get back home.
You are recovering from an illness and do not want to strain yourself by attending a party.
There are other parties that are planned in the recent future, so you could join them for that.
You might be hung-over the next day and you have an important presentation to make.
You do not have an outfit for the party and you cannot spend on it.
Other people are invited whom you are not comfortable with.

### Retaliation:

Your friends might feel bad if you decline their invite.
Your friend might stop inviting you, if you decline.
Your friend might judge you to be a party pooper for not coming.
You have a reputation of being a reliable person and you don't want it to change.
You fear it might create a scene if you tell no to your friends.
Your friends might take offence if you decline as they are very excited about the party.
You would be obligated to attend as it will be rude to decline, when they are so excited.
It might be difficult to tell no to your friends, as they are forcing you to go with them.
Your friends might stop talking to you if you say no.
You have never refused your friends earlier and might be impolite to refuse now.

Game C 204c game may be designed to enhance one's ability to weigh between the benefits of disagreeing and the fear of retaliation and/or losing good impression 225. The instruction 221c may include recommendation to play the game 204c for at least a predefined duration for a predefined number of days. The rules 223c may allow proceeding to a next level in the game 204c once a desired level of performance is achieved.

In the game C 204c, the user may be presented with situations/events and based on that the user may be presented with question for which the user may have to provide appropriate answers. An example is presented below with all the facts of which a subset will be displayed to the user.

### Situation/Event:

You have to move out of the apartment that you share with your friend as your job location is far and your friend on the other hand does not want you to move out.

### Benefits of Disagreeing:

If you move out of your friend's place to somewhere closer to the job location, you will be saving on time commuting.
You have plans of getting married in few years, so you would have to move out.
Your job is hectic, so you might have to work late as well. Hence, travelling long distance might be tiresome.
You might have more time to socialize with your colleagues.
As you save a lot of time from commuting, your hobbies could be pursued.
You will have the liberty to make your own decisions and be responsible.
The apartment that you have found has many amenities as compared to your current place.
By staying in a nearby apartment, the cost of living will be reduced to great extent in terms of travelling.
You wanted to stay alone before you get married.
This will be a chance for you to be independent as you have dreamt of.

### Retaliation:

Your friend will feel bad if you move out.
If your friend is offended, your relationship might be strained.
This might create a bad impression of you in your friend's mind.
Your other friends might start talking ill about you.
If you move out, your friend might think you are deserting him/her.
Your friend might not allow you to move out as he/she has always made decisions for you.
Your friend might not include you in different activities that you usually do together.
Your friend might be mad at you and begin to search for a new room-mate.
You might be considered as a selfish person if you think only about your happiness.
Your friend might emotionally manipulate you to stay back.
   Should you go ahead and tell your friend that you are leaving?Yes or No

Game D 204d game may be designed to enhance one's ability to weigh between the benefits of disagreeing and the fear of retaliation and/or losing good impression 225. The instruction 221d may include recommendation to play the game 204d for at least a predefined duration for a predefined number of days. The rules 223d may allow proceeding to a next level in the game 204d once a desired level of performance is achieved.

In the game D 204d, the user may be presented with scenario/situations/events and based on that the user may be presented with question for which the user may have to provide appropriate answers. An example is presented below.

### Situation/Scenario:

One of your friends comes home on a weekend to ask you a favor. This friend is very close to you, you know him to be a careless person who can be very lazy to complete any work. On a weekend, your friend comes to you requesting to complete one of his office works of documenting few files.

Question: So in this situation, what would you decide?

### Answer:

I should help him as he doubts me, he will think bad about me.
I should stand stern; otherwise, he will come again to do the same.
It's very important to make him realize that life can get little hard, he has to learn that.

Scenario/Situation:

This particular task will take at least a complete day. So your friend tells that he has personal commitment that he has to take care, because of which he's requesting you.

Question: So in this situation, what would you decide?

### Answer:

He has his reasons for coming to me, being his friend I should help him.
There are times where you come across situations where both of them are important to complete. So one has to learn how to manage in such situations.
No, if I agree today, he will always come to me for his works and which will make him more lazy and irresponsible.

### Situation/Scenario:

Your mother mentions to you that they are planning to go for an outing with the whole family.

Question: So in this situation, what would you decide?
I should consider my mother's plans as she is always at home.
Going out for an outing will be refreshing.
My friend will feel very offended.

### Situation/Scenario:

You make the decision to abide by your mother, now your friend is offended. This might end up spoiling the relationship that you two have developed for many years.

Question: So in this situation, what would you decide?

### Answer:

I should agree as I do not want him to think that I'm being mean.
He is emotional now. Let him calm down and then explain why I couldn't help him.
No, I really need to de-stress myself because only then I can go with fresh mind for the work the next day.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b (may be referred by numeral 220) or sets of real world activities 220a-220b (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others. Each level alternative should have an editable option where they can edit what is written and do what they think is feasible for that day. Whatever they write should be saved as that alternative and will show up 5 times.

The real world activity 220a may be presented to the user after the user has at least participated in one or more games (204a-204b) to a predefined extent that attempts to rewire 219 the first defective brain wiring 216a. The real world activity 220a may be designed to rewire the brain to increase the ability to focus more on the benefits of disagreeing. Instructions 227a may include recommendation that the action has to be carried out every day and rules 229a may state that each level has to be repeated 5 times, as an example, before the next level unlocks.

In a first level, the activity module 200 may provide instructions to choose a quiet place to sit in and close the eyes and imagine in detail what is shown. A list of tasks may be presented to the individual in a sequence.

Screen 1 shows the tasks as follows:
Imagine a situation where your beloved is requesting you for a favor which you do not want to do. Imagine yourself saying no to her/him. And by saying ‘no’, does not make her/him upset. By denying, you feel at peace of not carrying out the action without your interest. While imagining, keep breathing and relax yourself
Think of a situation, where someone is making fun of you. Imagine you stating to that particular person that you do not appreciate how he/she makes fun of you. While imagining, keep breathing and relax yourself.
Think of a situation where you in a place where there are many people around. Imagine yourself stating a need/concern in that situation. While imagining, keep breathing and relax yourself.
   Example: Someone barged into the queue.
Think of situation where you are making a request to one person. Imagine yourself making the request with ease and confidence. By requesting, you can be benefited. While imagining, keep breathing and relax yourself.
   Example: Requesting someone to work on something as you are overwhelmed.
Imagine yourself in a situation where you are saying ‘no’ to one person who is most dominant with ease and confidence. Imagine yourself being with confident body language.

In a second level, the activity module 200 presents a list of tasks to the individual in a sequence.

Screen 1 shows the tasks as follows:
During discussion with your friends, try to state your suggestions.
During lunch with colleagues, comment positively on others food.
Say no to one of your family member. And analyze the benefits of saying ‘no’.
When your friends are singing join them.

In a third level, the activity module 200 presents a list of tasks to the individual in a sequence.

Screen 1 shows the tasks as follows:
Request your boss/professor for permission to leave early one of the days. And analyze the benefit of stating your need.
Request your colleague/classmate to take over your work in your absence. And analyze the benefit of stating your need.
Ask your teammates/classmates to help you out with a project as you find them free from any work. And analyze the benefit of stating your need.
Ask your subordinates to complete the work as early as possible. And analyze the benefit of stating your need.
Ask your subordinates to be regular to office. And analyze the benefit of stating your need.

In a fourth level, the activity module 200 may present one or more tasks to the individual. Instructions may be as follows:
Meet a person who is a dominant. State a need/concern to that dominant person

Or
Say no to one of the dominant person

The real world activity 220b may be presented to the user after the user has at least participated in one or more games (204c-204d) to a predefined extent that attempts to rewire 225 the second defective brain wiring 216b. The real world activity 220b may be designed rewire the brain to increase the ability to weigh between the benefits of disagreeing and fear of retaliation and/or losing good impression 225. Instructions 227b may include recommendation that the action has to be repeated once in a week and rules 229b may state that each level has to be repeated a predefined number of times, before the next level unlocks.

In a first level, the activity module 200 may provide instructions to choose a quiet place to sit in and close the eyes and imagine in detail what is shown. A list of tasks may be presented to the individual in a sequence.

Screen 1 shows the list as follows:
Imagine yourself in a library (or any silent places), someone makes noise, imagine yourself asking him/her to maintain silence. Visualize yourself carrying out this action without thinking about the other person retaliating/thinking about losing your impression.
Think you are watching a drama/movie in a theatre, someone makes noise;

imagine yourself asking him/her to maintain silence. Visualize yourself carrying out this action without thinking about the other person retaliating/thinking about losing your impression.
Imagine you are traveling, the driver seems to be driving faster, so visualize yourself stating to the driver to slow down with ease and confidence. Visualize yourself carrying out this action without thinking about the other person retaliating/ thinking about losing your impression. Visualize yourself carrying out this action without thinking about the other person retaliating/ thinking about losing your impression.
Visualize yourself being on a call, and your friends/close are making noises. Request them to maintain silence for a while. Visualize yourself carrying out this action without thinking about the other person retaliating/ thinking about losing your impression.
Imagine yourself being in a situation where someone has not delivered a work up to your expectation, state to that particular person that you would like them to work on it again. Visualize yourself carrying out this action without thinking about the other person retaliating/ thinking about losing your impression.

In a second level, the activity module 200 presents a list of tasks to the individual in a sequence.

Screen 1 shows the list as follows:
In a restaurant, when a dish is not up to your expectation, call the waiter and request him for a replacement.
When you go to a place and if it's not maintained well ask them to clean.
   Example: Saloon is not well maintained.
When you are in a food point, and if the table is not cleaned, ask the concerned person to clean the table.
When you are in an office/mall and if the wash room is messy, ask the concerned person to make it proper.
When someone requests you to do a task, initially step to say no is to tell the individual that you need to think about it and you will get back to them. Just take the time by not saying a straight yes, so take time and then say yes to them. Carry out this action at least to 2 individuals in a day.

In a third level, the activity module 200 presents a list of tasks to the individual in a sequence.

Screen 1 shows the list as follows:
When someone is interrupting your conversation, politely stop them by telling that you were in the middle of telling something.
When you are in the middle of working on something and your friends call you for tea break, gently decline telling that you need to finish the task.
When you are studying/reading and your close ones ask you a favor, decline gently stating the reasons.
Make an effort to say ‘no’ the next day at least 4 individuals in a day. Take your time to decide and think of the reasons to tell no. Then tell the person that you cannot fit their work into your schedule as you have no time. Before saying yes or no, think about why the person has approached you, think about your workload.

### Screen 2:

On a scale of 1-10 how much would you rate your assertiveness. Write about how you manage to carry out the action. A box may be provided to the individual to provide his response.

In a fourth level, the activity module 200 presents a list of tasks to the individual in a sequence.

Screen 1 shows the list as follows:
State your discomfort when someone forces you to get their work done ahead of yours.
Refuse to lend money to a friend/ colleague who has repeatedly not paid you back.
Refuse to help your friend/close ones who repeatedly ask you for favors.
State your inconvenience to your boss who expects you to assist him in his personal errands.
Agree to disagree with your partner if your core believes are challenged.

### Screen 2:

On a scale of 1-10 how much would you rate your assertiveness. Write about how you manage to carry out the action. A box may be provided to the individual to provide his response.

In a fifth level, instructions may be provided to the user by the activity module 200 to mentor another individual who is submissive (and who wants to change) and guide them on the skills that you have learned. This person could be your friend/family member or colleague.

In an embodiment, the action database 206 further includes plurality of physical actions, mind actions and dietary actions, one or more of which may be presented to a user who is trying to overcome submissiveness 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Submissiveness

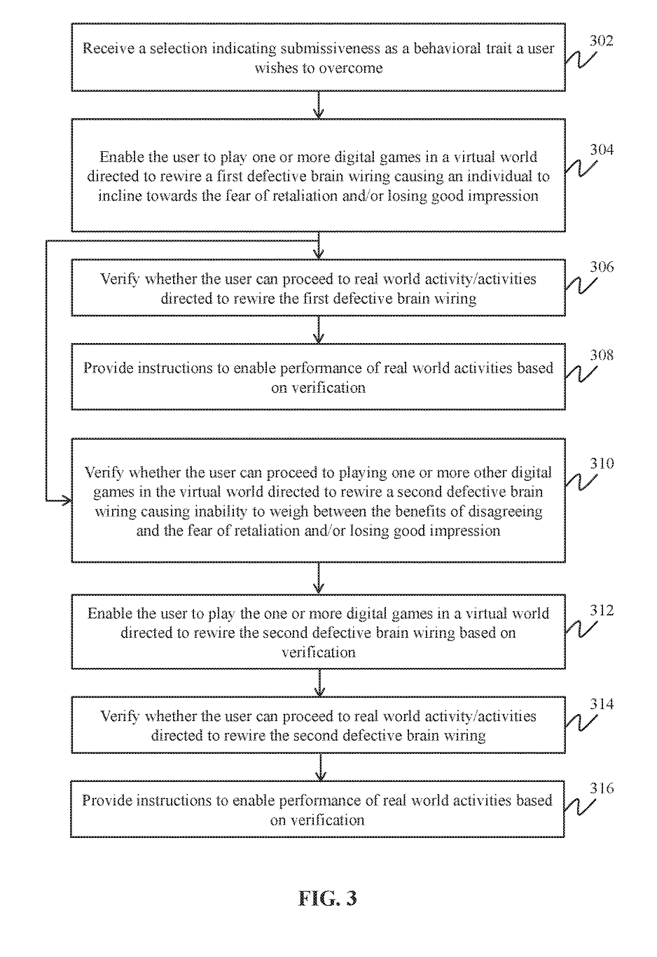

Now referring more particularly to FIG. 3, a method is provided for overcoming submissiveness 214a. A selection indicating submissiveness 214a as a behavioral trait which a user wishes to overcome is received at step 302. At step 304, a user is enabled to play/participate in one or more digital games 204a and/or 204b, which are played in a virtual world. The digital games 204a and 204b are instrumental in rewiring 219, a first defective brain wiring 216a, whose symptom is exhibition of submissiveness 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. Likewise, the user is allowed to perform or instructed to begin performing appropriate real world activities 220a upon participating in the digital game 204b at least to a predefined extent. In another embodiment, the user may be allowed to perform or instructed to begin performing appropriate real world activities 220a upon participating in each digital game 204a and 204b at least to a predefined extent. The real world activity 220a is instrumental in rewiring 219 the first defective brain wiring 216a, whose symptom is exhibition of submissiveness 214a.

At step 310, verification is made to determine whether the user can proceed to playing at least one other digital game 204c and/or 204d in the virtual world directed to rewire a second defective brain wiring 216b. In case it is determined that the user can proceed, then at step 312 the user is enabled to play/participate in one or more digital games 204c and/or 204d, which are played in a virtual world. The digital games 204c-204d are instrumental in rewiring 225 the second defective brain wiring 216b, whose symptom is exhibition of submissiveness 214a. Preferably, the user is allowed to proceed to playing digital games 204c-204d upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in the digital game(s) 204c-204d at least to a predefined extent, which is determined based on the desired rewiring. The real world activity/activities 220b are instrumental in rewiring 225 the second defective brain wiring 216b, whose symptom is exhibition of submissiveness 214a.

Referring to the step (302) of receiving a selection indicating submissiveness 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of submissiveness 214a, the activity module 200 may display a list 216d of other behavioral traits that can be confused with submissiveness 214a, so that the user can select a more appropriate behavioral trait 214, which he desires to work on. The activity module 200 may further display the information corresponding to the brain wirings (defect) 216a, 216b causing the trait behavioral 214. The first defective brain wiring 216a causes the individual to incline towards the fear of retaliation and/or losing good impression. The second defective brain wiring 216b causes inability to weigh between the benefits of disagreeing and the fear of retaliation and/or losing good impression.

The activity module 200 may additionally display information about impact 216c of submissiveness 214a to the user. In addition, the activity module 200 may display information corresponding to the brain rewiring 219, 225 that the activity module 200 is attempting to achieve to overcome submissiveness 214a. Rewiring 219 of the first defective brain wiring 216a results in increased ability to focus more on the benefits of disagreeing. Rewiring 225 of the second defective brain wiring 216b results in increased ability to weigh between the benefits of disagreeing and the fear of retaliation and/or losing good impression.

Furthermore, the activity module 200 may display the information corresponding to the causes (genetic or environmental) that resulted in the defective brain wirings (defect) 216a, 216b.

Referring to the step (304) of enabling the user to play one or more digital games in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and duration over which the game 204 was played.

In an embodiment, the activity module 200 recommends participating in real world activity 220a or a part thereof, after the user has performed to a desired extent in the digital game 204a. Likewise, the activity module 200 may recommend participating in the real world activity 220a or a part thereof, after the user has performed to a desired extent in the digital game 204b. Further, the activity module 200 may recommend participating in the real world activity 220a or a part thereof, after the user has performed to a desired extent in each digital game 204a and 204b. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing one or more other digital games in the virtual world directed to rewire the second defective brain wiring 216b causing an individual to fail in weighing between the benefits of disagreeing and the fear of retaliation and/or losing good impression. Rewiring the second defective brain wiring 216b results in increased ability to weigh between the benefits of disagreeing and the fear of retaliation and/or losing good impression.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities 220a directed to rewire the first defective brain wiring 216a.

The activity module 200, based on the verification, enables the user to play/participate in one or more other digital games 204c and 204d in the virtual world directed to rewire the second defective brain wiring.

In an embodiment, the activity module 200 recommends participating in real world activity 220b or part thereof after the user has performed to a desired extent in the digital game 204c. Likewise, the activity module 200 recommends participating in real world activity 220b or part thereof after the user has performed to a desired extent in the digital game 204d.

In another embodiment, the activity module 200 recommends participating in digital game 204b after the user has performed to a desired extent in a level of the digital game 204a. Similarly, the activity module 200 recommends participating in digital game 204d after the user has performed to a desired extent in a level of the digital game 204c.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting submissiveness, the activity module 200 provides a scale operable by the user to select a position on the scale. The position may be indicative of the user's perception of his submissiveness. Improvement in eradication of alleviation of submissiveness resulting from the rewiring of the brain achieved by the performance of the activities (virtual games or real world activities) enabled by the activity module 200 is reflected on the scale. Degradation in eradication of alleviation of submissiveness resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome submissiveness, the system comprising an activity module configured to:
enable the user to engage in at least a first activity in a virtual environment, wherein the first activity is directed to rewire a first defective wiring of the brain, wherein the first defective wiring results in inclination towards the fear of retaliation and/or losing good impression;
enable the user to engage in at least a second activity in the virtual environment, wherein the second activity is directed to rewire a second defective wiring of the brain, wherein the second defective wiring results in inability to weigh between the benefits of disagreeing and the fear of retaliation and/or losing good impression, wherein symptom of the first and the second defective wirings is submissiveness;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to
provide the automated instructions to engage in the activity directed to rewire the first defective wiring to be performed in the real world environment, after the user has at least participated in the first activity.

4. The system of claim 1, wherein the activity module is further configured to
provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome submissiveness, the method comprising:
enabling the user to engage in at least a first activity in a virtual environment, wherein the first activity is directed to rewire a first defective wiring of the brain, wherein the first defective wiring results in an individual inclining towards the fear of retaliation and/or losing good impression;
enabling the user to engage in at least a second activity in the virtual environment, wherein the second activity is directed to rewire a second defective wiring of the brain, wherein the second defective wiring results in inability to weigh between the benefits of disagreeing and the fear of retaliation and/or losing good impression, wherein symptom of the first and the second defective wirings is submissiveness;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity, after the user has at least participated in the first activity.

11. A system for enabling a user to overcome submissiveness, the system comprising an activity module configured to:
enable the user to engage in at least a first activity in a virtual environment, wherein the first activity is directed to rewire a first defective wiring of the brain, wherein the first defective wiring results in inclination towards the fear of retaliation and/or losing good impression; and
enable the user to engage in at least a second activity in the virtual environment, wherein the second activity is directed to rewire a second defective wiring of the brain, wherein the second defective wiring results in inability to weigh between the benefits of disagreeing and the fear of retaliation and/or losing good impression, wherein symptom of the first and the second defective wirings is submissiveness, wherein engagement in the second activity is enabled after the user has at least participated in the first activity.

12. The system of claim 11, wherein,
the first activity is directed to rewire the first defective wiring to increase the ability to focus more on the benefits of disagreeing; and
the second activity is directed to rewire the second defective wiring to increase the ability to weigh between the benefits of disagreeing and the fear of retaliation and/or losing good impression.
